(19) United States
(12) Patent Application Publication
(10) Pub. No.: US 2007/0159443 A1
(43) Pub. Date: Jul. 12, 2007

(54) Methods of operating source driving circuits having D/A converter test capabilities for liquid crystal display devices and related source driving circuits

(76) Inventor: Nam-Jung Her, Suwon-si (KR)

Correspondence Address: MYERS BIGEL SIBLEY & SAJOVEC, PO BOX 37428, RALEIGH, NC, 27627, US

(21) Appl. No.: 11/328,973

(22) Filed: Jan. 10, 2006

(51) Int. Cl. G09G 3/36

(52) U.S. Cl. 345/100

(57) ABSTRACT

An LCD source driving circuit includes a gray voltage generator and a D/A converter. The gray voltage generator receives reference gray voltages to generate gray voltages having 2ⁿ different voltage levels. The D/A converter has 2ⁿ conversion paths and selects one gray voltage according to a received n-bit data among the 2ⁿ gray voltages to output the selected gray voltage. The source driving circuit may adjust voltage differences between the neighboring conversion paths when testing the D/A converter.

### FIELD OF THE INVENTION

The present invention relates to liquid crystal displays (LCD) and, more particularly, to methods of operating source driving circuits for LCDs and related source driving circuits.

### BACKGROUND OF THE INVENTION

In recent years, liquid crystal displays (LCD) have started to replace cathode ray tube devices in many applications. By way of example, many television screens and computer monitors are now implemented using LCD devices, which are typically thinner and lighter than cathode ray tube screens.

Both passive and active matrix LCD devices are known in the art. Active matrix LCD devices have multiple active elements that are coupled, respectively, to multiple pixel electrodes that are aligned within a matrix of the LCD device. Active matrix LCD devices typically have higher contrast ratios than passive matrix LCD devices. Thin film transistors (TFT) are widely used as the active element that connects to the pixel electrodes of the active matrix LCD device.

FIG. 1 is a schematic diagram illustrating a conventional source driving circuit for an LCD device that includes a 2-bit digital-to-analog (D/A) converter 10. As shown in FIG. 1, the D/A converter 10 has four conversion paths. The D/A converter 10 has four gray voltage inputs, V1 through V4. The D/A converter 10 selects and outputs one of these gray voltages V1 through V4 based on a received data code DATA. The output signal VDO of the D/A converter 10 is buffered by a buffer 20 before it is output. The output signal VOUT is coupled to one of source lines (not shown) in an LCD panel.

FIG. 2 is a diagram illustrating how the D/A converter of FIG. 1 should operate. As indicated in FIG. 2, when a data code 00 is input to the D/A converter 10, the D/A converter 10 will output voltage V1, so long as it is working properly. Likewise, when that data codes 01, 10 and 11 are input, the D/A converter will output voltages V2, V3 and V4, respectively, when operating properly, as reflected by the boxes labeled “GOOD” in FIG. 2. In FIG. 2, the boxes labeled “BAD” indicate instances where the D/A converter does not operate properly.

An error in the signal VOUT may occur because of (1) a malfunction with respect to the D/A converter 10 or (2) a malfunction in the buffer 20. If the buffer 20 fails, the output of the D/A converter will typically fail for each of the conversion paths. Accordingly, the D/A converter may be tested to determine if it is operating properly by confirming that each of the conversion paths output the correct signal. The conventional method for testing the D/A converter 10 and the buffer 20 is to serially input the data code DATA that selects each conversion path of the D/A converter 10 and then measure the DC voltage levels of the output signal VOUT to determine if the proper voltage was output. This testing may be done, for example, as part of a chip-based test of a source driving circuit of an LCD device.

### SUMMARY OF THE INVENTION

Pursuant to embodiments of the present invention, methods of operating a source driving circuit of an LCD device are provided. Pursuant to these methods, a first set of gray voltage levels is provided to respective ones of a plurality of conversion paths of a D/A converter of the source driving circuit when the circuit is used to drive the LCD device. In contrast, a second set of gray voltage levels, that is different from the first set of gray voltage levels, is provided to respective of the plurality of conversion paths of the D/A converter when the D/A converter is tested.

In certain embodiments, at least eight conversion paths are provided, and the second set of gray voltage levels may have at most three different gray voltage levels that are provided to the at least eight conversion paths. In other embodiments, the differences between the gray voltage levels provided to at least some pairs of neighboring conversion paths during testing of the D/A converter may be greater than the differences between the gray voltage levels provided to the same pairs of neighboring conversion paths when the source driving circuit is used to drive the LCD device. In some embodiments, at least two of the gray voltages in the second set of gray voltage levels may have the same value. In certain specific embodiments, at least two of the gray voltages in the second set of gray voltage levels may be equal to the voltage level of a first reference voltage that is provided to the source driving circuit. In some embodiments, the gray voltage level provided to all or all but one of the conversion paths during testing of the D/A converter may be either the voltage level of the first reference voltage or the voltage level of a second reference voltage provided to the source driving circuit.

Pursuant to further embodiments of the present invention, methods of operating a source driving circuit of an LCD device are provided in which a different gray voltage level is provided to each of the 2ⁿ conversion paths of a D/A converter of the source driving circuit when the source driving circuit is used to drive the LCD device. In contrast, the same gray voltage level is provided to at least two of the 2ⁿ conversion paths during testing of the D/A converter. In these methods, the difference between the gray voltage level provided to a first of the conversion paths and the gray voltage level provided to a second of the conversion paths that is adjacent the first conversion path during testing of the D/A converter may be approximately equal to a difference between a highest reference voltage applied to a gray voltage generator circuit of the source driving circuit and a lowest reference voltage applied to the gray voltage generator circuit. In certain specific embodiments, the gray voltage level provided to at least 2ⁿ−1 of the conversion paths during testing of the D/A converter is either the highest reference voltage or the lowest reference voltage.

Pursuant to further embodiments of the present invention, source driving circuits for an LCD device are provided that include a gray voltage generator that is configured to output at least eight distinct gray voltage levels on respective ones of at least eight output lines when the source driving circuit is used to drive the LCD device. These source driving circuits further include a D/A converter that has at least eight conversion paths that are coupled to respective ones of the at least eight output lines. The output lines are matched to the conversion paths so that the difference between the gray voltage levels provided to any two adjacent conversion paths exceeds the smallest difference between any two of the eight gray voltage levels.

Pursuant to still further embodiments of the present invention, source driving circuits for an LCD device are provided that include a gray voltage generator that is responsive to a plurality of reference gray voltages. The gray voltage generator may be configured to generate gray voltages having 2ⁿ different voltage levels. A D/A converter having 2ⁿ conversion paths is also provided, the D/A converter configured to select and output one of the 2ⁿ gray voltages based on a received n-bit data. In these embodiments, n is an integer number, a respective one of the 2ⁿ gray voltages corresponds to each of the 2ⁿ conversion paths, and the voltage differences between the gray voltages corresponding to neighboring conversion paths may be adjustable for testing the D/A converter.

The D/A converter may be functionally tested by using the voltage differences between the neighboring conversion paths. The gray voltage generator may include first to fourth lines respectively provided with the first to the fourth reference gray voltages. A first resistor may be connected between the first line and a first node, a second resistor may be connected between the first node and a second node, a third resistor may be connected between the second node and the second line, a fourth resistor may be connected between the third line and a third node, a fifth resistor may be connected between the third node and the fourth line, a sixth resistor may be connected between the second line and a fourth node, and a seventh resistor may be connected between the fourth node and the third line. The gray voltage generator also may generate first to eighth gray voltages, the first gray voltage indicating a voltage level of the first line, the second gray voltage indicating a voltage level of the first node, the third gray voltage indicating a voltage level of the second node, the fourth gray voltage indicating a voltage level of the second line, the fifth gray voltage indicating a voltage level of the fourth node, the sixth gray voltage indicating a voltage level of the third line, the seventh gray voltage indicating a voltage level of the third node, and the eighth gray voltage indicating a voltage level of the fourth line.

The D/A converter may include first to eighth conversion paths configured to respectively output the first to the eighth gray voltages corresponding to a 3-bit data. The first and the second reference gray voltages may be about 5V, and the third and the fourth reference gray voltages may be about 0V.

### BRIEF DESCRIPTION OF THE DRAWINGS

FIG. 1 is a schematic diagram illustrating a conventional source driving circuit for an LCD device that includes a 2-bit digital-to-analog (D/A) converter.

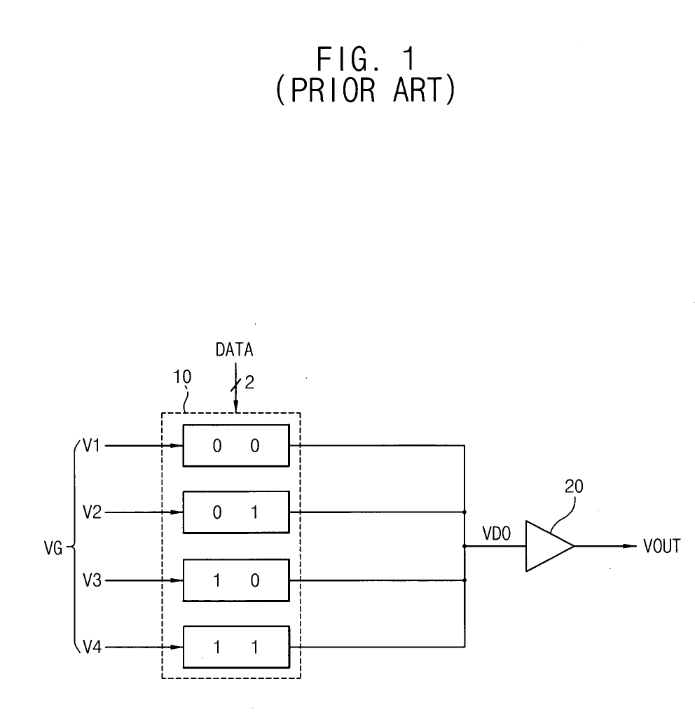

FIG. 2 is a diagram illustrating the proper outputs of the D/A converter of FIG. 1.

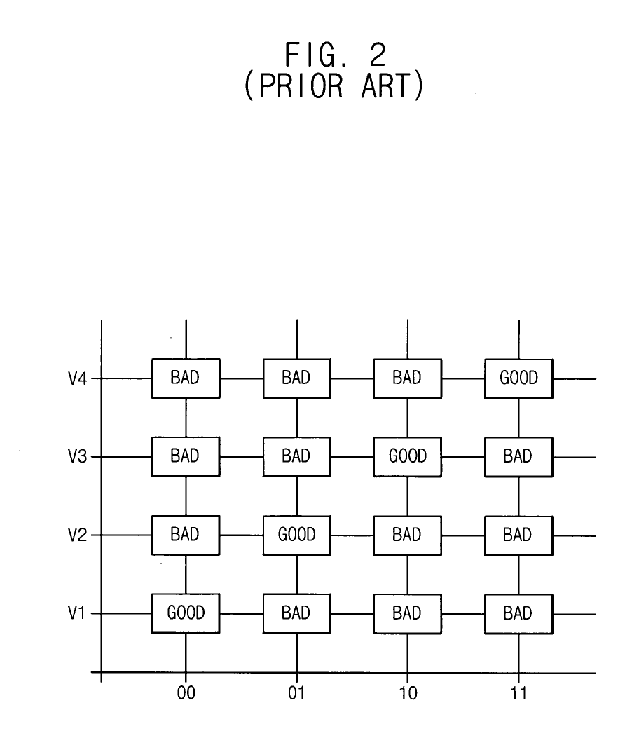

FIG. 3 is a schematic diagram illustrating a conventional source driving circuit of an LCD device that includes a 3-bit D/A converter.

FIG. 4 is a schematic diagram illustrating a source driving circuit of an LCD device with a 3-bit D/A converter according to embodiments of the present invention.

FIG. 5 is a schematic diagram illustrating the source driving circuit in FIG. 4 with reference gray voltages for testing the D/A converter.

FIG. 6 is a schematic diagram illustrating a source driving circuit of an LCD device with a 3-bit D/A converter according to further embodiments of the present invention.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements and/or components, these elements and/or components should not be limited by these terms. These terms are only used to distinguish one element or component from another element or component. Thus, a first element or component discussed below could be termed a second element or component without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

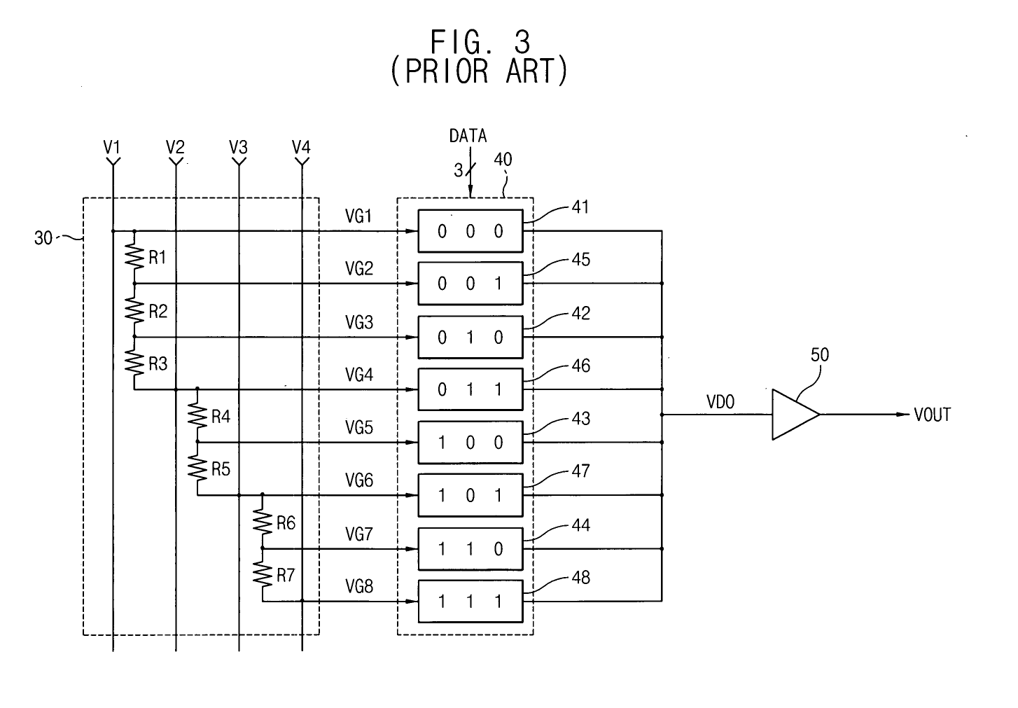

FIG. 3 is a schematic diagram illustrating a conventional source driving circuit of an LCD device that includes a 3-bit D/A converter. As shown in FIG. 3, the source driving circuit includes a gray voltage generator 30, a D/A converter 40 and a buffer 50. The gray voltage generator 30 receives reference gray voltages V1 to V4, and generates 8 different gray voltage levels VG1 to VG8. The D/A converter 40 has 8 conversion paths 41 to 48, each of which selects the one of the gray voltage levels VG1 to VG8 that corresponds to the input data code DATA, and outputs the selected gray voltage as the output signal VDO. The output signal VDO is buffered in the buffer 50, and then output as output signal VOUT.

The gray voltage generator 30 includes resistors R1, R2 and R3, which are connected in series between the reference gray voltages V1 and V2, resistors R4 and R5, which are connected in series between the reference gray voltages V2 and V3, and resistors R6 and R7, which are connected in series between the reference gray voltages V3 and V4.

At a normal operation, the reference gray voltages V1 to V4 may have sequentially decreasing values, for example, 5V, 2.8V, 1.4V, and 0V respectively, so that the gray voltage generator 30 generates the eight distinct gray voltage levels, by way of example, substantially uniformly distributed from 5V to 0V.

The source driving circuit shown in FIG. 3 operates as follows. The input data DATA comprises 3 bits of data, and the number of the conversion paths of the D/A converter is 8, that is, 2³. The reference gray voltages V1 to V4 are converted by one or more of the resistors R1 to R7 into the gray voltages VG1 to VG8. When one conversion path among the 8 conversion paths is selected according to the input data DATA, the gray voltage that corresponds to the selected conversion path is output as the output voltage VDO of the D/A converter 40. The output voltage VDO is buffered by the buffer 50, and then output as the output voltage VOUT to one of source lines of the LCD panel (not shown).

As shown in FIG. 3, the first conversion path 41 of the D/A converter 40 is selected by the input data 000. The second conversion path 42 of the D/A converter 40 is selected by the input data 001. The third conversion path 43 of the D/A converter 40 is selected by the input data 010. The fourth conversion path 44 of the D/A converter 40 is selected by the input data 011. The fifth conversion path 45 of the D/A converter 40 is selected by the input data 100. The sixth conversion path 46 of the D/A converter 40 is selected by the input data 101. The seventh conversion path 47 of the D/A converter 40 is selected by the input data 110. The eighth conversion path 48 of the D/A converter 40 is selected by the input data 111.

The data 000 selects the first conversion path 41 of the D/A converter 40, and the D/A converter outputs the gray voltage VG1 as the output voltage VDO. The data 001 selects the second conversion path 42 of the D/A converter 40, and the D/A converter outputs the gray voltage VG2 as the output voltage VDO. The data 010 selects the third conversion path 43 of the D/A converter 40, and the D/A converter outputs the gray voltage VG3 as the output voltage VDO. The data 011 selects the fourth conversion path 44 of the D/A converter 40, and the D/A converter outputs the gray voltage VG4 as the output voltage VDO. The data 100 selects the fifth conversion path 45 of the D/A converter 40, and the D/A converter outputs the gray voltage VG5 as the output voltage VDO. The data 101 selects the sixth conversion path 46 of the D/A converter 40, and the D/A converter outputs the gray voltage VG6 as the output voltage VDO. The data 110 selects the seventh conversion path 47 of the D/A converter 40, and the D/A converter outputs the gray voltage VG7 as the output voltage VDO. The data 111 selects the eighth conversion path 48 of the D/A converter 40, and the D/A converter outputs the gray voltage VG8 as the output voltage VDO.

At a test operation, the reference gray voltages V1 to V4 have the same value. For example, all of the reference gray voltages V1 to V4 are 3.3V, then all of the gray voltages are also 3.3V.

In order to determine if the conversion paths 41 to 48 of the D/A converter 40 in the source driving circuit in FIG. 3 are operating properly, the reference gray voltages V1 to V4 with the same DC voltage levels are provided to the D/A converter 40, and the eight possible data codes DATA are then serially input. For each of these eight tests, the output VOUT is checked to confirm that the expected output signal is received.

The D/A converter according to FIG. 3, however, is not easily verified for interferences between the conversion paths because all of the conversion paths are provided with the reference gray voltages having the same DC voltage level.

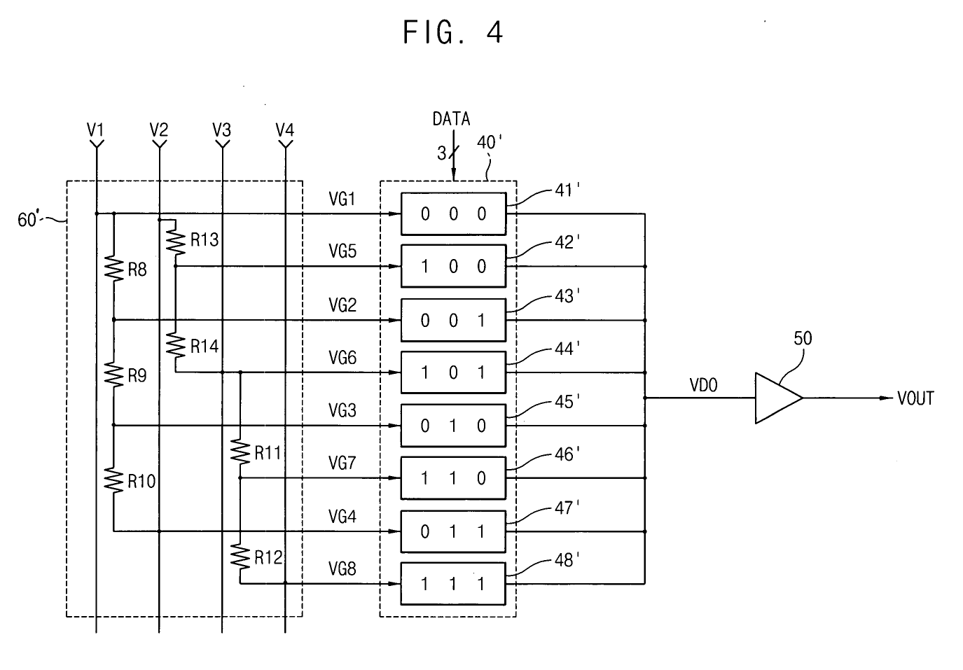

FIG. 4 is a schematic diagram illustrating a source driving circuit of an LCD device with a 3-bit D/A converter according to embodiments of the present invention. As shown in FIG. 4, the source driving circuit includes a gray voltage generator 60′, a D/A converter 40′ and a buffer 50 that receives 3-bit input data DATA. The gray voltage generator 60′ receives reference gray voltages V1 to V4 and generates 8 different gray voltage levels VG1 to VG8. The D/A converter 40′ has 8 conversion paths 41′ to 48′, each of which selects the one of the gray voltage levels VG1 to VG8 that corresponds to the input data code of the conversion path. An output signal VDO that has the gray voltage level corresponding to the input data DATA is buffered by the buffer 50, and then output as signal VOUT.

The gray voltage generator 60′ includes resistors R8, R9 and R10, which are connected in series between the reference gray voltages V1 and V2, resistors R13 and R14, which are connected in series between the reference gray voltages V2 and V3, and resistors R11 and R12, which are connected in series between the reference gray voltages V3 and V4.

At a normal operation, the reference gray voltages V1 to V4 may have sequentially decreasing values, for example, 5V, 2.8V, 1.4V, and 0V respectively, so that the gray voltage generator 30 generates the eight distinct gray voltage levels, by way of example, substantially uniformly distributed from 5V to 0V.

The LCD device source driving circuit shown in FIG. 4 operates as follows. The input data DATA is 3-bit data. The resistors R8 to R14 are used to generate the gray voltages VG1 to VG8 from the reference gray voltages V1 to V4. One of the 8 conversion paths is selected based on the input data DATA, and the gray voltage corresponding to the selected conversion path is output from the D/A converter 40′ as the output voltage VDO. The output voltage VDO is buffered by the buffer 50, and then provided as output voltage VOUT to one of source lines of the LCD panel (not shown).

As shown in FIG. 4, the first conversion path 41′ of the D/A converter 40′ is selected by the input data 000. The second conversion path 42′ of the D/A converter 40′ is selected by the input data 001. The third conversion path 43′ of the D/A converter 40′ is selected by the input data 010. The fourth conversion path 44′ of the D/A converter 40′ is selected by the input data 011. The fifth conversion path 45′ of the D/A converter 40′ is selected by the input data 100. The sixth conversion path 46′ of the D/A converter 40′ is selected by the input data 101. The seventh conversion path 47′ of the D/A converter 40′ is selected by the input data 110. The eighth conversion path 48′ of the D/A converter 40′ is selected by the input data 111.

The data 000 selects the first conversion path 41′ of the D/A converter 40′, and the D/A converter outputs the gray voltage VG1 as the output voltage VDO. The data 001 selects the second conversion path 42′ of the D/A converter 40′, and the D/A converter outputs the gray voltage VG2 as the output voltage VDO. The data 010 selects the third conversion path 43′ of the D/A converter 40′, and the D/A converter outputs the gray voltage VG3 as the output voltage VDO. The data 011 selects the fourth conversion path 44′ of the D/A converter 40′, and the D/A converter outputs the gray voltage VG4 as the output voltage VDO. The data 100 selects the fifth conversion path 45′ of the D/A converter 40′, and the D/A converter outputs the gray voltage VG5 as the output voltage VDO. The data 101 selects the sixth conversion path 46′ of the D/A converter 40′, and the D/A converter outputs the gray voltage VG6 as the output voltage VDO. The data 110 selects the seventh conversion path 47′ of the D/A converter 40′, and the D/A converter outputs the gray voltage VG7 as the output voltage VDO. The data 111 selects the eighth conversion path 48′ of the D/A converter 40′, and the D/A converter outputs the gray voltage VG8 as the output voltage VDO.

As shown in FIG. 4, the conversion paths of the D/A converter 40′ are configured in a different order as compared to the conversion paths of the conventional D/A converter 40 of FIG. 3. In particular, while the conversion paths of the D/A converter 40 of the conventional source driving circuit of FIG. 3 are arranged in a consecutive order increasing from 000 to 111, the conversion paths of the D/A converter 40′ of FIG. 4 are arranged in a mixed order of the first conversion path 41′, the fifth conversion path 45′, the second conversion path 42′, the sixth conversion path 46′, the third conversion path 43′, the seventh conversion path 47′, the fourth conversion path 44′ and the eighth conversion path 48′. The gray voltages associated with each of the respective conversion paths 41′ to 48′ of the D/A converter 40′ in FIG. 4 are substantially the same as the corresponding gray voltages in FIG. 3. Thus, in the D/A converter 40′ of FIG. 4, the gray voltage VG1 corresponds to the input data 000, the gray voltage VG2 corresponds to the input data 001, the gray voltage VG3 corresponds to the input data 010, the gray voltage VG4 corresponds to the input data 011, the gray voltage VG5 corresponds to the input data 100, the gray voltage VG6 corresponds to the input data 101, the gray voltage VG7 corresponds to the input data 110 and the gray voltage VG8 corresponds to the input data 111. The D/A conversion result of the source driving circuit in FIG. 4 is substantially equal to the D/A conversion result from FIG. 3.

The arrangement of the conversion paths of the D/A converter 40′ of the source driving circuit in FIG. 4 may allow for easier testing of the D/A converter 40′ than the consecutive arrangement of the conversion paths in the D/A converter 40 of FIG. 3.

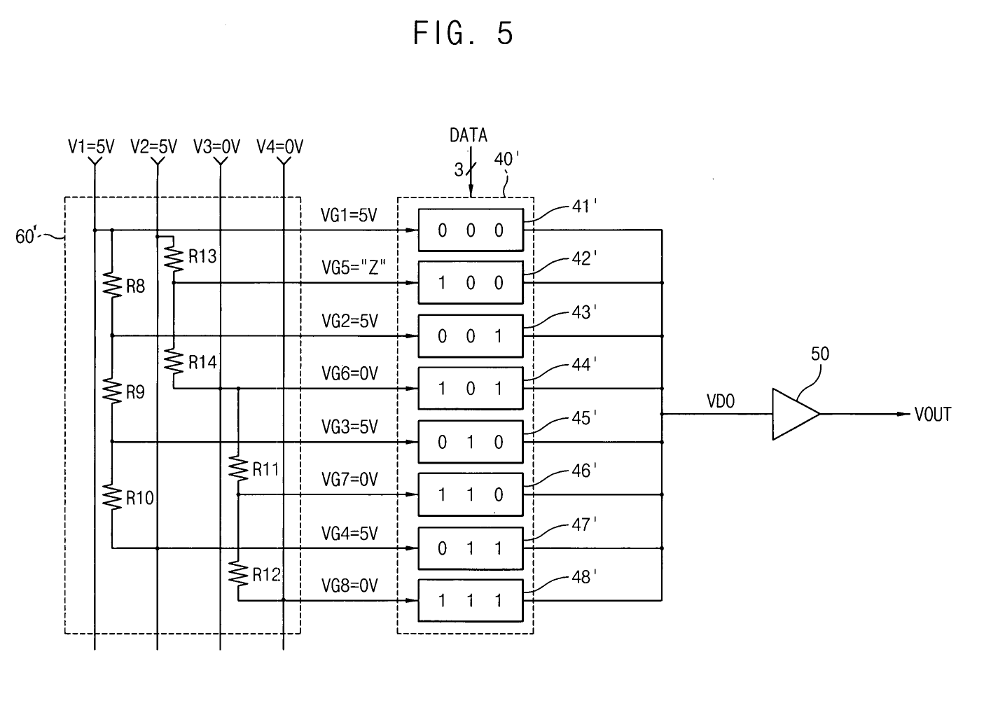

FIG. 5 is a schematic diagram illustrating the source driving circuit in FIG. 4 provided with reference gray voltages for testing the D/A converter. As shown in FIG. 5, a 5V voltage is applied to the reference gray voltages V1 and V2, respectively and a 0V voltage is applied to the reference gray voltages V3 and V4, respectively. Because the reference gray voltages V1 and V2 are 5V, there is no voltage drop across the resistors R8, R9 and R10, and the gray voltages VG1, VG2, VG3 and VG4 are each 5V. Similarly, because the reference gray voltages V3 and V4 are 0V, there are no voltage drops across the resistors R11 and R12, and the gray voltages VG6, VG7 and VG8 are each 0V. The gray voltage VG5 has a voltage level Z in a range from 0V to 5V, where the value of Z depends on the values of the resistors R13 and R14.

Voltage differences between adjacent conversion paths of the D/A converter 40′ with the configuration of FIG. 5, except for voltage differences with respect to the fifth conversion path 45′, are 5V. The fifth conversion path 45′ has a voltage level Z. Z is greater than 0V but less than 5V, as determined by the values of the resistors R13 and R14. The voltage level Z is sufficiently distinguishable. In this way, the fifth conversion path 45′ may be tested. The other conversion paths may be tested in a similar way. For another example, if the gray voltages V1, V2 and V3 are 5V, and the gray voltage V4 is 0V, then the gray voltages VG1 to VG6 are 5V and the gray voltage V8 is 0V, but the gray voltage VG7 is a value between 5V and 0V which is apparently distinguishable. The seventh conversion path 47′ may be tested in such a configuration.

The source driving circuit in FIG. 5 can detect defects where the source driving circuit is short-circuited or open-circuited, by such a function test. The configuration in FIG. 5 may have larger voltage differences among adjacent conversion paths than the configuration in FIG. 3, which may reduce the time necessary to perform the tests and/or increase the accuracy of the tests.

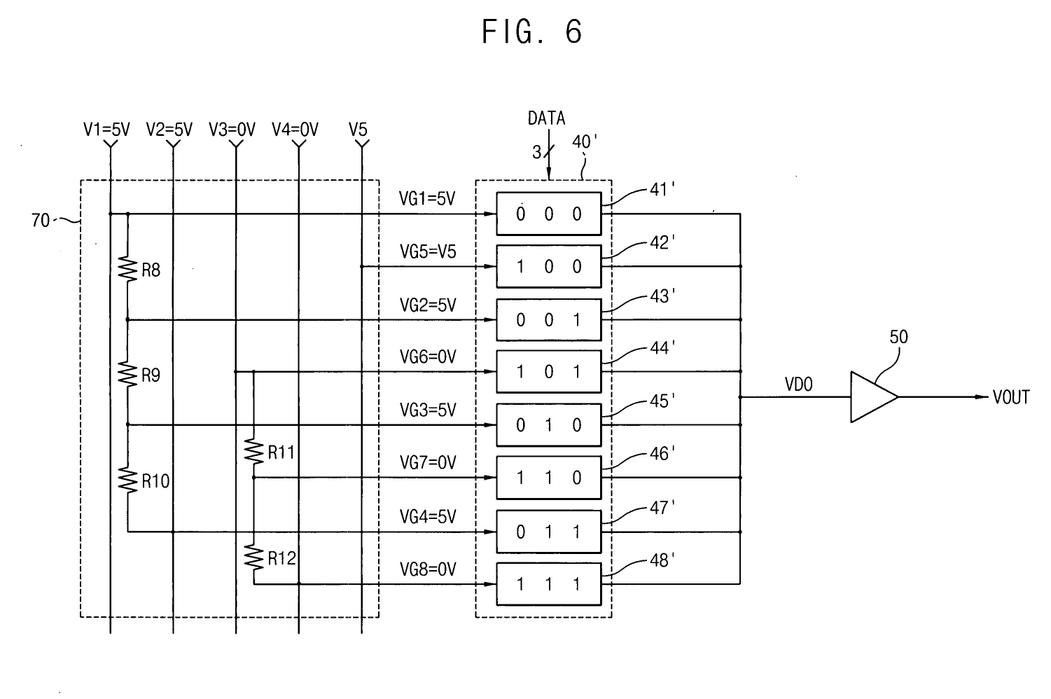

FIG. 6 is a schematic diagram illustrating a source driving circuit of an LCD device with a 3-bit D/A converter according to further embodiments of the present invention. In the embodiment of FIG. 6, the D/A converter 40′ receives 5 different reference gray voltages having voltage levels V1 to V5, as compared to the 4 different gray voltage levels provided in the embodiment of FIG. 5. The reference gray voltage V5 may be used to supply the gray voltage VG5. The gray voltage VG5 in FIG. 6 has a voltage level of the reference gray voltage V5, while the gray voltage VG5 in FIG. 5 has a voltage level in a range between the reference gray voltages V1, which is 5V, and V3, which is 0V, depending on the resistors R13 and R14.

The operation of the source driving circuit illustrated in FIG. 6 is substantially identical to the operation of the source driving circuit illustrated in FIG. 5, and thus, a detailed description need not be repeated here.

A source driving circuit for an LCD device according to embodiments of the present invention may easily detect defects of the D/A conversion paths of the D/A converter by testing the conversion paths functionally. A source driving circuit for an LCD device according to the embodiments of the invention may also reduce time for testing and/or improve the accuracy of the tests.

The foregoing is illustrative of the present invention and is not to be construed as limiting thereof. Although a few example embodiments of this invention have been described, those skilled in the art will readily appreciate that many modifications are possible in the example embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of operating a source driving circuit of an LCD device, the source driving circuit including a D/A converter, the method comprising:
providing a first set of gray voltage levels to respective ones of a plurality of conversion paths of the D/A converter when the source driving circuit is used to drive the LCD device; and
providing a second set of gray voltage levels, that is different from the first set of gray voltage levels, to respective ones of the plurality of conversion paths of the D/A converter when testing the D/A converter,
wherein the differences between the gray voltage levels provided to at least some pairs of neighboring conversion paths, which include at least one conversion path under test during testing of the D/A converter, is greater than the differences between the gray voltage levels provided to the at least some pairs of neighboring conversion paths when the source driving circuit is used to drive the LCD device.

2. The method of claim 1, wherein the plurality of conversion paths comprises at least eight conversion paths, and wherein the second set of gray voltage levels comprises at least three different gray voltage levels that are provided to the at least eight conversion paths.

3. The method of claim 1, wherein at least two of the gray voltages in the second set of gray voltage levels have the same value.

4. The method of claim 1, wherein at least two of the gray voltages in the second set of gray voltage levels comprise the voltage level of a first reference voltage provided to the source driving circuit.

5. The method of claim 4, wherein the gray voltage level provided to all but at least one of the conversion paths under test during testing of the D/A converter are either the voltage level of the first reference voltage or the voltage level of a second reference voltage provided to the source driving circuit, and a gray voltage level provided to the at least one of the conversion paths under test during testing of the D/A converter is a voltage level between the first reference voltage and the second reference voltage.

6. A method of operating a source driving circuit of an LCD device, the source driving circuit including a D/A converter having 2ⁿ conversion paths, the method comprising:
providing a different gray voltage level to each of the 2ⁿ conversion paths of the D/A converter when the source driving circuit is used to drive the LCD device; and
providing a same gray voltage level to at least two of the 2ⁿ conversion paths, wherein the at least two of the 2ⁿ conversion paths are not under test, during testing of the D/A converter,
wherein the differences between the gray voltage levels provided to at least some pairs of neighboring conversion paths, which include at least one conversion path under test during testing of the D/A converter, is greater than the differences between the gray voltage levels provided to the at least some pairs of neighboring conversion paths when the source driving circuit is used to drive the LCD device.

7. The method of claim 6, wherein the gray voltage level provided to all but at least one of the conversion paths under test during testing of the D/A converter are approximately equal either to a highest reference voltage applied to a gray voltage generator circuit of the source driving circuit, or to a lowest reference voltage applied to the gray voltage generator circuit of the source driving circuit, and a gray voltage level provided to the at least one of the conversion paths under test during testing of the D/A converter is a voltage level between the highest reference voltage and the lowest reference voltage.

8. A source driving circuit for an LCD device, comprising:
a gray voltage generator that is configured to output at least eight distinct gray voltage levels on respective of at least eight output lines, based on at least four reference voltages when the source driving circuit is used to drive the LCD device, and configured to output at least three distinct gray voltage levels for the at least eight output lines during testing; and
a D/A converter having at least eight conversion paths that are coupled to respective of the at least eight output lines, wherein the output lines are matched to the conversion paths so that the difference between the gray voltage levels provided to any two adjacent conversion paths exceeds the smallest difference between any two of the eight gray voltage levels when the source driving circuit is used to drive the LCD device.

9. The circuit of claim 8, wherein the gray voltage level provided to all but at least one of the conversion paths under test during testing of the D/A converter are approximately equal either to a highest one of the reference voltage applied to the gray voltage generator circuit, or to a lowest reference voltage applied to the gray voltage generator circuit, and a gray voltage level provided to the at least one of the conversion paths under test during testing of the D/A converter is a voltage level between the highest reference voltage and the lowest reference voltage.

10. A source driving circuit for an LCD device comprising:
a gray voltage generator that is responsive to a plurality of reference gray voltages, the gray voltage generator configured to generate gray voltages having 2ⁿ different voltage levels; and
a D/A converter having 2ⁿ conversion paths, the D/A converter configured to select and output one of the 2ⁿ gray voltages based on a received n-bit data,
wherein n is an integer, wherein a respective one of the 2ⁿ gray voltages corresponds to each of the 2ⁿ conversion paths, and wherein voltage differences between the gray voltages corresponding to neighboring conversion paths are adjustable for testing the D/A converter.

11. The source driving circuit of claim 10, wherein the D/A converter is functionally tested by using the voltage differences between the neighboring conversion paths.

12. The source driving circuit of claim 11, wherein the number n is 3, and wherein the gray voltage generator comprises:
a first line provided with a first of the reference gray voltages;
a second line provided with a second of the reference gray voltages;
a third line provided with a third of the reference gray voltages;
a fourth line provided with a fourth of the reference gray voltages;
a first resistor connected between the first line and a first node;
a second resistor connected between the first node and a second node;
a third resistor connected between the second node and the second line;
a fourth resistor connected between the third line and a third node;
a fifth resistor connected between the third node and the fourth line;
a sixth resistor connected between the second line and a fourth node; and
a seventh resistor connected between the fourth node and the third line, and
wherein the gray voltage generator generates first to eighth gray voltages, the first gray voltage indicating a voltage level of the first line, the second gray voltage indicating a voltage level of the first node, the third gray voltage indicating a voltage level of the second node, the fourth gray voltage indicating a voltage level of the second line, the fifth gray voltage indicating a voltage level of the fourth node, the sixth gray voltage indicating a voltage level of the third line, the seventh gray voltage indicating a voltage level of the third node, and the eighth gray voltage indicating a voltage level of the fourth line.

13. The source driving circuit of claim 12, wherein the D/A converter comprises first to eighth conversion paths configured to respectively output the first to the eighth gray voltages.

14. The source driving circuit of claim 13, wherein the first and the second reference gray voltages are about 5V, and the third and the fourth reference gray voltages are about 0V.

15. The source driving circuit of claim 11, wherein the number n is 3, and wherein the gray voltage generator comprises:
a first line provided with a first of the reference gray voltages;
a second line provided with a second of the reference gray voltages;
a third line provided with a third of the reference gray voltages;
a fourth line provided with a fourth of the reference gray voltages;
a first resistor connected between the first line and a first node;
a second resistor connected between the first node and a second node;
a third resistor connected between the second node and the second line;
a fourth resistor connected between the third line and a third node; and
a fifth resistor connected between the third node and the fourth line, and
wherein the gray voltage generator generates first to eighth gray voltages, the first gray voltage indicating a voltage level of the first line, the second gray voltage indicating a voltage level of the first node, the third gray voltage indicating a voltage level of the second node, the fourth gray voltage indicating a voltage level of the second line, the fifth gray voltage indicating a voltage level of the fifth node, the sixth gray voltage indicating a voltage level of the third line, the seventh gray voltage indicating a voltage level of the third node, and the eighth gray voltage indicating a voltage level of the fourth line.

16. The source driving circuit of claim 15, wherein the D/A converter comprises first to eighth conversion paths configured to respectively output the first to the eighth gray voltages.
